(19) United States
(12) Patent Application Publication
(10) Pub. No.: US 2022/0141416 A1
(43) Pub. Date: May 5, 2022

(54) Video Recorder Power Source

(71) Applicant: Trijicon, Inc., Wixom, MI (US)

(72) Inventors: Mark W. LISTER, Berkley, MI (US); Alex CHOU, Rochester Hills, MI (US); Thomas K. MACIAK, Brighton, MI (US); Jeremiah MAURICIO, Tecumseh, MI (US)

(21) Appl. No.: 17/088,796

(22) Filed: Nov. 4, 2020

(51) Int. Cl. H04N 5/765; G11B 33/02; F41A 17/06

(52) U.S. Cl. CPC H04N 5/765; H02J 7/0045; F41A 17/06; G11B 33/022

(57) ABSTRACT

A video recorder battery pack for a firearm includes a housing, a power supply, and a port in the housing. The power supply is disposed within the housing. The port is configured to connect with a video source and is configured to simultaneously receive a video output from the video source and provide power to the video source.

### FIELD

The present disclosure relates to a video recorder for a firearm, and, more particularly, to a video recorder for a firearm that also functions as an auxiliary power source.

### BACKGROUND

This section provides background information related to the present disclosure which is not necessarily prior art.

Firearms are typically aimed at a target disposed along an operator's line of sight. The firearms may include a scope or optic for magnifying or otherwise displaying the target. Video cameras are sometimes combined with the scope or optic to record images and events as they happen in real time. The recordings may then be viewed later for various reasons.

### SUMMARY

This section provides a general summary of the disclosure, and is not a comprehensive disclosure of its full scope or all of its features.

At least one example embodiment of a video recorder battery pack for a firearm according to the present disclosure includes a housing, a power supply, and a port in the housing. The power supply is disposed within the housing. The port is configured to connect with a video source and is configured to simultaneously receive a video output from the video source and provide power to the video source.

In at least one example embodiment, the port may be a universal serial bus (USB) port.

In at least one example embodiment, the port may include at least four pins. At least two of the at least four pins may be configured to permit data flow, and at least two of the at least four pins may be configured to permit power flow.

In at least one example embodiment, the video source is a digital optic.

In at least one example embodiment, the port is configured to provide power to external devices other than the video source.

In at least one example embodiment, a power controller may be configured to control power supply through the port. The power controller may be configured to detect a cable attachment, a cable detachment, and a cable orientation. The power controller may be configured to determine power delivery supply, enable a power path, and determine a voltage and current output for the power. The voltage and current output may be based on the power delivery supply.

In at least one example embodiment, a microphone may be disposed in the housing. The microphone may be configured to receive sound.

In at least one example embodiment, a video controller may be configured to mate the video output from the video source and sound received by the microphone.

In at least one example embodiment, the power supply may be a battery and the port may be configured to connect with an external power supply to charge the battery.

In at least one example embodiment, a mount may be fixed to the housing and may be configured to mount the housing to a firearm or a firearm accessory.

In at least one example embodiment, the port may be configured to receive the video output from the video source in real time as images are captured by the video source.

At least one example embodiment of a video recorder battery pack for a firearm according to the present disclosure includes a housing, a port, a microphone, and a controller. The port is disposed in the housing and is configured to receive a video output from a video source. The microphone is configured to receive sound. The controller is configured to combine the video output from the video source with the sound received by the microphone.

In at least one example embodiment, the port is further configured to simultaneously provide power to the video source.

In at least one example embodiment, the video source is a digital optic, and the port is a universal serial bus (USB) port.

At least one example embodiment of a battery pack for a firearm according to the present disclosure includes a housing, a controller, a strap slot, and a mechanical mount. The housing is configured to be mounted to a firearm. The controller is configured to provide power to an external device and is disposed within the housing. The strap slot is integral with the housing and is configured to receive a strap to mount the housing. The mechanical mount is integral with the housing and is configured to mount the housing to the firearm or a firearm accessory.

In at least one example embodiment, the mechanical mount is one of a rail mount, a mount knob, a lever, a screw, or a fastener.

In at least one example embodiment, a lanyard loop is integral with the housing, the lanyard loop being configured to receive a lanyard.

In at least one example embodiment, the housing includes a plurality of lanyard loops or a plurality of strap slots.

In at least one example embodiment, the external device is a video source and the controller is configured to simultaneously receive a video output from the video source and provide power to the video source through a single port in the housing.

In at least one example embodiment, the video source is a digital optic.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a bottom perspective view of an example embodiment of a video recorder according to the present disclosure.

FIG. 2 is a top perspective view of the video recorder in FIG. 1.

FIG. 3 is a side view of the video recorder in FIG. 1.

FIG. 4 is a cross sectional view of the video recorder in FIG. 1, taken at line 4-4 in FIG. 2.

FIG. 5 is a top perspective view of an example embodiment of a power storage and circuitry housed in the video recorder in FIG. 1.

FIG. 6 is a bottom perspective view of the power storage and circuitry in FIG. 5.

FIG. 7 is a schematic view of an example embodiment of a control system for the video recorder in FIG. 1.

FIG. 8 is a flowchart for an example method for providing power from the video recorder to an external device.

FIG. 9 is a flowchart for an example method for receiving, processing, and storing video from an external device.

FIG. 10 is a flowchart for an example method for simultaneously providing power and receiving video through a port in the video recorder in FIG. 1.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module,” the term “unit,” or the term “controller” may be replaced with the term “circuit.” The term “module” or the term “unit” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module or unit may include one or more interface circuits. In some examples, the interface circuits may include wired or wireless interfaces that are connected to a local area network (LAN), the Internet, a wide area network (WAN), or combinations thereof. The functionality of any given module or unit of the present disclosure may be distributed among multiple modules or units that are connected via interface circuits. For example, multiple modules or units may allow load balancing. In a further example, a server (also known as remote, or cloud) module or unit may accomplish some functionality on behalf of a client module or unit.

The term code, as used above, may include software, firmware, and/or microcode, and may refer to programs, routines, functions, classes, data structures, and/or objects. The term shared processor circuit encompasses a single processor circuit that executes some or all code from multiple modules or units. The term group processor circuit encompasses a processor circuit that, in combination with additional processor circuits, executes some or all code from one or more modules or units. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules or units. The term group memory circuit encompasses a memory circuit that, in combination with additional memories, stores some or all code from one or more modules or units.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

A video recorder according to the present disclosure serves both as an external video recorder (which is configured to record, as examples, digital or analog video) and as an auxiliary power source. The video recorder may be used in conjunction with a video source, such as an optic (for example, a thermal optic or electro-optics). For example, the optic may be a Trijicon® thermal optic, such as a Trijicon® REAP-IR® Mini Thermal Riflescope, a Trijicon® IR-HUNTER® Thermal Riflescope, a Trijicon® IR-PATROL® Thermal Monocular, a Trijicon® SNIPE-IR® Thermal Clip-on, or another thermal optic. Along with providing a video feed, the video source may internally record and save the video, or the video source may simply provide a video feed without internally storing the file. Additionally, the video source may include sound with the video feed or my only provide image data.

The video recorder may include a housing that encases a power supply and control circuitry and is configured to be mounted to a firearm. The housing may define a port that is configured to receive a cable connection for connecting the video recorder to the video source, for example, by a cable. The port may be configured to simultaneously receive a video output from the video source and provide power to the video source.

The housing may include one or more integrated mounts configured to directly mount the video recorder to the firearm. The integrated mounts may include a mount knob, a rail mount, a lever, a screw, or another mechanical device for mounting the video recorder to the firearm. Alternatively, or in addition to the integrated mount, the video recorder may include one or more integrally formed strap slots and/or lanyard loops. The strap slot may receive a strap for mounting the housing to a user, the firearm, the video source, or an external device. The lanyard loop may receive a lanyard for carrying or transporting the video recorder.

In operation, a single button may turn power on/off and may start/stop video recording (as opposed to multiple buttons for multiple functions). The video recorder may receive communication from the video source through a cable (for example, a USB-C) and records (for example, digitally records) and stores the video on a storage device. For example, the storage device may be an internal storage device or a removable storage device, such as a removable card or micro SD card.

The video recorder may record audio via a microphone on the video recorder. The audio may be correlated and combined with the video input from the video source and stored on the storage device.

The cable may provide power to the video source from the video recorder. For example, the video recorder may receive video communication from the video source and simultaneously provide power to the video source through the single port in the video recorder. An internal power storage, such as a battery, of the video recorder may be recharged using the same cable by connecting it to an external power source, such as, for example, a wall outlet or other charging source. A series of LEDs (such as five, for example) may provide feedback to the user regarding power storage and active recording.

Thus, the present disclosure provides a highly functional video recorder and combined power supply that may be mounted on a firearm, user, or other device in a number of different ways, with each mount being seamlessly integrated into the housing of the video recorder for ease of use and functionality. The video recorder may have a single port that can simultaneously receive video and provide power to an external device. The cable may then be disengaged from the external device and engaged with an external power source to charge the video recorder. A microphone receives sound that may be combined with video image files from the external device, and a memory card slot receives an external storage card for saving the video and audio files. When not recording, the video recorder may function as a standalone power supply for an external device.

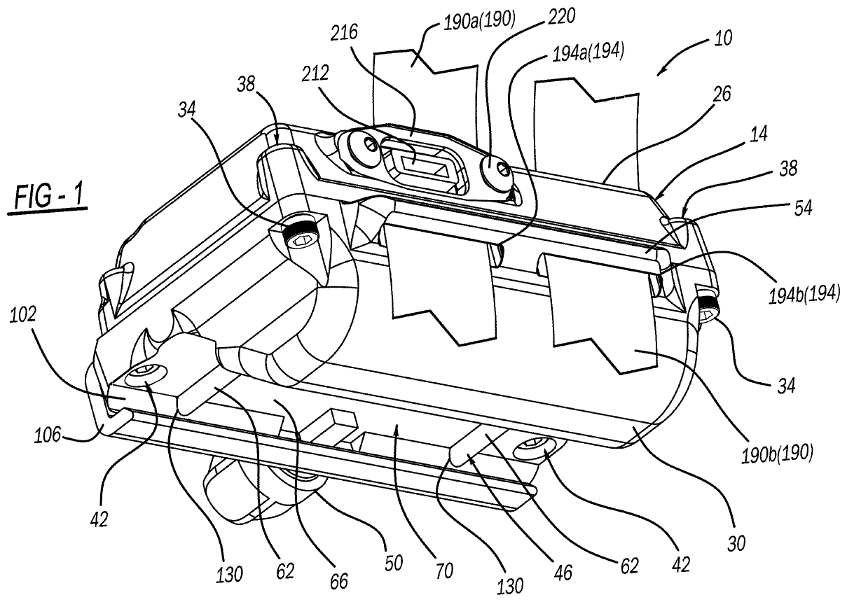

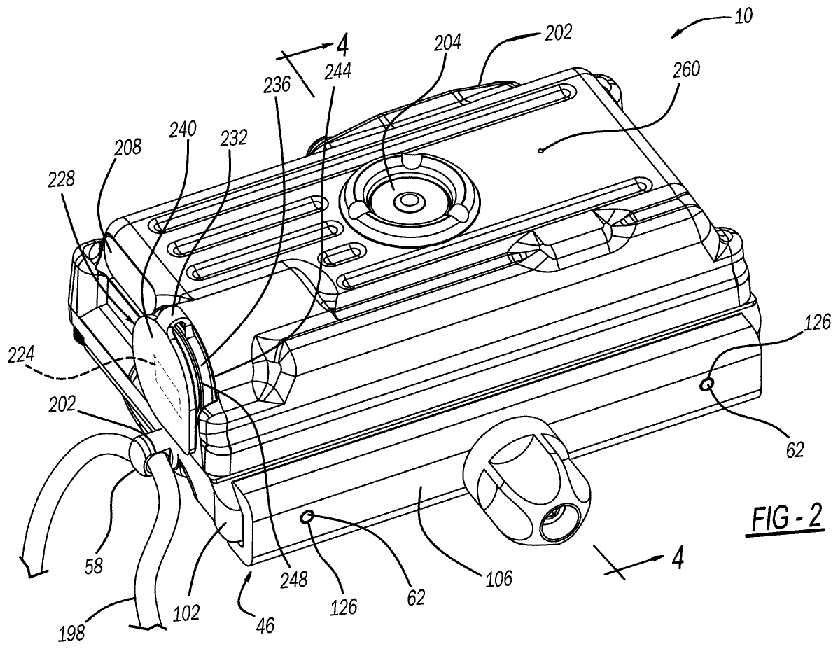

Now referring to FIGS. 1 and 2, a video recorder 10 according to the present disclosure is illustrated. The video recorder 10 may include a housing 14 enclosing internal components including a power storage 18 and circuitry 22, described below. For example, the housing 14 may be a metal housing (such as steel, aluminum, or an alloy), a polymer housing (such as plastic or Kevlar®), or any other suitable material. For example, the housing 14 may be a stamped metal housing, a forged metal housing, a molded housing (for example, injection or blow molded), a 3-D printed housing, or any other appropriately formed housing.

The housing 14 may be a two-piece, or two-part, housing 14, having a top half 26 and a bottom half 30 fixed together by fasteners 34. For example, the fasteners 34 may each be received within an aperture 38 in the top half 26 that is aligned with an aperture 42 in the bottom half 30. The apertures 38, 42 may be disposed within the corners of the top half 26 and the bottom half 30, respectfully, or may be disposed anywhere feasible in the top half 26 and the bottom half 30.

The housing 14 may be configured to mount to a firearm or other external device or be transported in various ways. For example, the housing 14 may include a mechanical mount to fix the housing 14 on a firearm, another external device, or to carry for transport. A variety of mechanical mounts may be provided on the housing for versatility. For example, the mechanical mounts may include a rail mount 46 having a mounting post 50, a strap mount 54, a lanyard mount 58, or a combination thereof. The rail mount 46, the strap mount 54, and the lanyard mount 58 may be formed integrally with the housing 14.

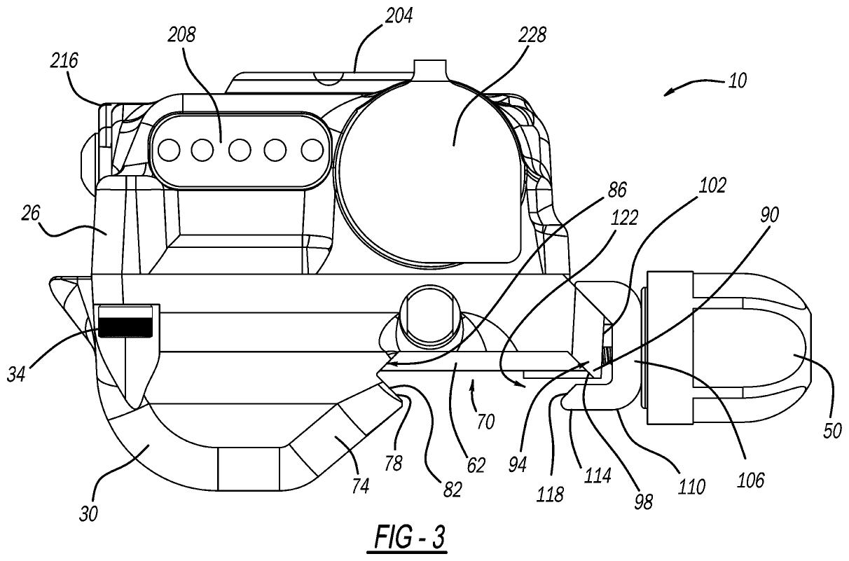

With additional reference to FIG. 3, the rail mount 46 may be configured to mount the housing 14 directly to a rail of a firearm. The rail mount 46 may be a two-piece rail mount secured by at least one pin or fastener 62 (for example two fasteners) and the mounting post 50. For example, the pin 62 may be a dowel pin or other suitable pin. For example, the fastener 62 may be a screw, a lever, or another suitable fastener.

The housing 14 may include a first, or bottom, surface 66 for mounting the housing 14 to the firearm. The first surface 66 may be within a recess or channel 70 in the bottom half 30 of the housing 14, such that when engaged with the firearm, the housing 14 extends partially over the sides of the firearm. The first surface 66 may engage with a slide, a top surface, or a rail of the firearm. A projection 74 may define one longitudinal side 78 of the channel 70 and may engage the firearm to secure the housing 14 to the firearm. The projection 74 may have an inner edge 82 that is sloped for mating with an edge of the top surface, or rail, of the firearm. The inner edge 82 may additionally include a channel 86 extending along its length. The channel 86 may be “V”-shaped, “U”-shaped, squared, etc. for receiving the edge of the top surface, or rail, of the firearm.

An opposing longitudinal projection 90 may define an opposing longitudinal side 94 of the channel 70 and may engage the firearm to cooperate with the projection 74 to secure the housing 14 to the firearm. The projection 90 may have an inner edge 98 that is sloped for mating with an edge of the top surface, or rail, of the firearm. The projection 90 may include an outer surface 102 forming a support ledge that is configured to receive a clamp 106 that cooperates with the projection 90 and projection 74 to secure the housing 14 to the firearm. The clamp 106 may be “V”-shaped, “U”-shaped, squared, etc. for mating with the outer surface 102 of the projection 90. A first arm 110 of the clamp 106 may include an end 114 having a surface 118 sloped to align with the inner edge 98 of the projection 90 to create a channel 122 that mirrors the channel 86 in the inner edge 82 of projection 74.

The clamp 106 and channel 122 may extend along a length of the projection 90 and may be “V”-shaped, “U”-shaped, squared, etc. for receiving an opposite edge of the top surface, or rail, of the firearm. The projection 74, projection 90, and clamp 106 may cooperate to clamp or secure the housing 14 on the firearm. The pins or fasteners 62 may extend through apertures 126 in the clamp 106 and apertures 130 the projection 102 and inserted into apertures (not shown) in the projection 74. For example, and the fasteners 62 may be threaded into apertures (not shown) in the projection 74 to clamp and secure the housing 14 onto the firearm. Therefore, the fasteners 62 may prevent the housing 14 from moving relative to the firearm.

The mounting post 50 may be configured to tighten the clamp 106 to clamp or secure the housing 14 on the firearm. The mounting post 50 may include a fastener (for example, a screw) 134, a spacer (for example, a washer) 138, and a cap 142. The spacer 138 may be a tubular spacer, having an aperture 146 for receiving the fastener 134 therethrough. For example, the spacer 138 may be a cylindrical spacer having a circular cross section, or may have any shaped cross section including, for example, rectangular, elliptical, triangular, pentagonal, hexagonal, polygonal, or any other shape. The spacer 138 may be formed of metal, (such as steel, aluminum, or an alloy), a polymer (such as plastic or Kevlar®), an elastomer (such as rubber), or any other suitable material.

While the mounting post 50 is illustrated and described as including the fastener 134, the spacer 138, and the cap 142, it is understood that this is an example embodiment of the mounting post 50, and the mounting post 50 may be a lever or other mechanical fastener to secure and/or tighten the clamp 106.

The spacer 138 may fit within a recess 150 in a base surface 154 of the cap 142. The cap 142 includes a grip 158 on a side of the cap 142 opposite the base surface 154. Similar to the spacer 138, the cap 142 may be a tubular cap 142, having an aperture 162 for receiving the fastener 134 therethrough. For example, the cap 142 may be a cylindrical cap having a circular cross section, or may have any shaped cross section including, for example, rectangular, elliptical, triangular, pentagonal, hexagonal, polygonal, or any other shape. The cap 142 may be formed of metal, (such as steel, aluminum, or an alloy), a polymer (such as plastic or Kevlar®), an elastomer (such as rubber), or any other suitable material.

The aperture 162 in the cap 142 may include three sections: the recess 150, a neck 166, and a body 170. The recess 150 may have a diameter larger than both a diameter of the neck 166 and a diameter of the body 170 and sized to receive the spacer 138 therein. The diameter of the body 170 may be larger than the diameter of the neck 166 such that a head 174 of the fastener 134 fits within the body 170 of the cap 142 but cannot pass through the neck 166. The diameter of the neck 166 may be slightly larger than a diameter of a shaft 178 of the fastener 134 such that the shaft 178 fits therein. The neck 166 may additionally include threads 182 that engage with threads 186 on the shaft 178 of the fastener 134.

In use, a portion of a firearm or other external device on which the housing 14 is to be mounted is clamped between the clamp 106 and the inner edge 82 of the longitudinal side 78 of the projection 74. The fastener 134 may extend through an aperture in the portion of the firearm or external device that is clamped. The fastener 134 is threaded into an aperture 188 in the support ledge 102 having threads 192 that engage the threads 186 on the fastener 134. Threads 192 and threads 182 cooperate with threads 186 of the fastener 134 to secure the fastener 134, the clamp 106, and the mounting post 50 relative to the housing 14.

The strap mount 54 may be configured to receive at least one strap 190 (for example, multiple straps, such as two straps 190a, 190b) for mounting the housing 14 directly to a firearm, an external device, or a user. The at least one strap 190 may be a flexible strap. For example, the strap 190 may be a flat flexible strap, such as a belt, strip, or band. The strap 190 may be a fabric strap (formed from a nylon, cloth, or other material), a polymer (such as woven plastic or Kevlar®), an elastomer (such as rubber), etc.

The strap mount 54 may be integrally formed with the housing 14 and may define at least one aperture 194 (for example, multiple apertures, such as two apertures 194a, 194b) for receiving the strap(s) 190. For example, the strap mount 54 may be a projection extending from a side of the housing 14 opposite the clamp 106. The strap mount 54 may be formed of the same material as the housing 14 (since it is formed as a portion of the housing). For example, the strap mount 54 may be formed of metal (such as steel, aluminum, or an alloy), a polymer (such as plastic or Kevlar®), or any other suitable material.

In use, the aperture(s) 194 in the strap mount 54 may receive the strap(s) 190. The strap(s) 190 may then be fastened (for example, tied, hook-and-loop fastened, buckled, or otherwise fastened) around the firearm, external device, or user to secure the housing 14 thereto.

The lanyard mount 58 may be configured to receive at least one lanyard 198 for transporting the housing 14. The lanyard 198 may be a flexible strip, such as a rope, cord, cable, thread, twine, etc. The lanyard 198 may be a fabric rope (formed from a braided or solid nylon, cloth, or other material), a polymer (such as woven or solid plastic or Kevlar®), an elastomer (such as rubber), etc.

The lanyard mount 58 may be integrally formed with the housing 14 and may define an aperture 202 for receiving the lanyard 198. For example, the lanyard mount 58 may be a projection extending from a side of the housing 14. The lanyard mount 58 may be formed of the same material as the housing 14 (since it is formed as a portion of the housing). For example, the lanyard mount 58 may be formed of metal (such as steel, aluminum, or an alloy), a polymer (such as plastic or Kevlar®), or any other suitable material.

In use, the aperture 202 in the lanyard mount 58 may receive the lanyard 198. Ends of the lanyard 198 may then be fastened (for example, tied, hook-and-loop fastened, buckled, or otherwise fastened) to create a loop for transporting the housing 14.

A power button 204 may protrude through a surface of the housing 14 and may be configured to selectively turn on and off power and selectively start and stop recording. For example, the power button 204 may be a single, push-button switch that selectively turns power on/off and start/stops video recording (as opposed to multiple buttons for multiple functions). Alternatively, the power button 204 may be a toggle switch, rocker switch, slide switch, rotary switch, other switches, or combinations thereof. In operation, the single button 204 may turn power on/off and may start/stop video recording (as opposed to multiple buttons for multiple functions), reducing parts, cost, and ease of use.

A series of lights (for example, five lights) 208 may provide feedback to the user regarding power storage and active recording. For example, the lights 208 may each be a light-emitting diode (LED). The lights 208 may illuminate based on available power. For example, if all lights are illuminated, the power storage 18 may be fully charged; if two or three lights are illuminated, the power storage 18 may be half charged; if zero lights are illuminated, the power storage 18 may have very little or no charge. One of the series of lights may indicate whether active recording is enabled. For example, if the light is on, recording may be enabled, and if the light is off, recording may be disabled. The series of lights may be different colors to differentiate between the functions. For example, battery charge state may be indicated by yellow, green, or white lights, while recording may be indicated by a red light.

An aperture, or slot, 212 in the housing 14 may be configured to receive an external storage card (not illustrated). The external storage card may communicate with internal components housed within the housing 14, as described later. The aperture 212 may be an elongate aperture and may have a rectangular, a rounded rectangular, or an elliptical shape. Alternatively, the aperture 212 may have any shape that receives an external storage card.

The aperture 212 may be protected by a cover 216. The cover 216 may prevent dust and debris from entering the aperture 212. The cover 216 may be fixed on the body. For example, the cover 216 may be connected to the housing 14 by a hinge (either living hinge, or other hinge), by one or more fasteners 220 (for example, two fasteners), by glue, or by any other connection.

An aperture, or slot, 224 in the housing 14 may be configured to receive a connector for a cable (not illustrated). For example, the connector may be a universal serial bus (USB) connector, and more specifically, a USB Type-C connector. Alternatively, the connector may be any applicable connector for transmitting power and data. The connector may communicate with internal components housed within the housing 14, as described later. The aperture 224 may be an elongate aperture and may have a rectangular, a rounded rectangular, or an elliptical shape. Alternatively, the aperture 224 may have any shape that receives a connector for a cable.

The aperture 224 may be protected by a cover 228. The cover 228 may prevent dust and debris from entering the aperture 224. The cover 228 may be fixed on the body. For example, the cover 228 may be connected to the housing 14 by a hinge (either living hinge, or other hinge) 232 or by one or more fasteners (for example, two fasteners).

More specifically, the cover 228 may include a base, or ring, 236, a cap 240, and the hinge 232. The cover 228 may be formed as a single, integral part. The cover 228 may be formed of an elastomer (for example rubber), or any other acceptable material.

The base 236 may be attached to the housing 14. For example, the base 236 may be positioned within a channel 244 on a protrusion 248 of the housing 14 surrounding the aperture 224. The hinge 232 may then allow the cap 240 to pivot between a position covering the aperture 224 and an open position.

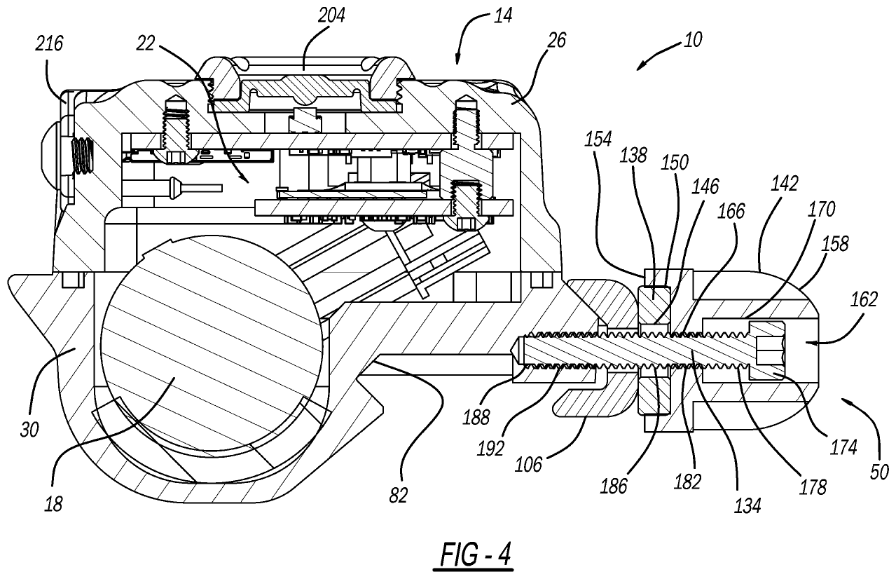

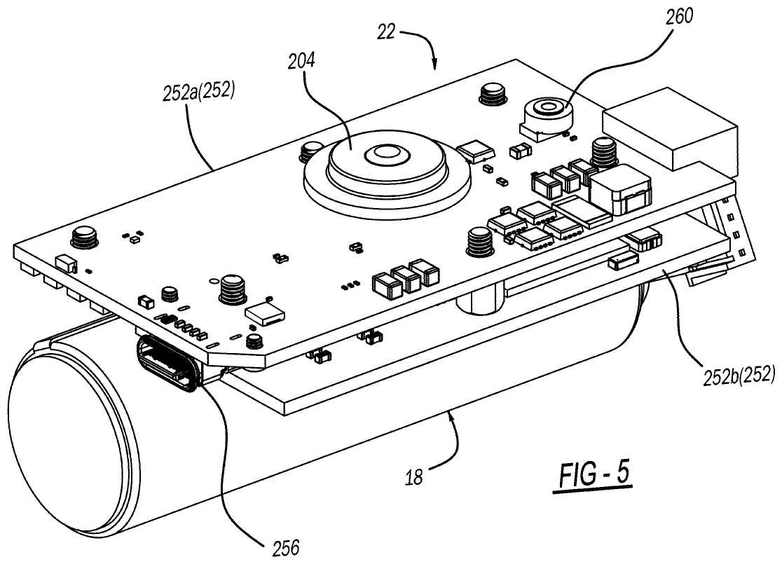

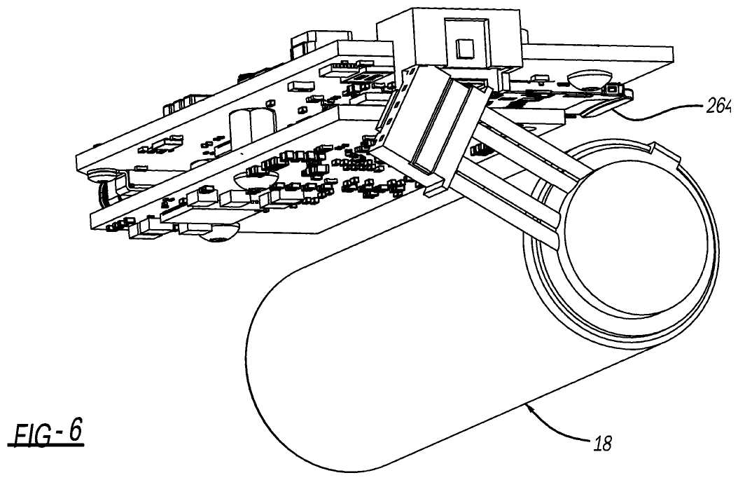

Now referring to FIGS. 4-6, the housing 14 may enclose internal components including the power storage 18 and circuitry 22. The power storage 18 may be configured to be a rechargeable power storage that may be charged from an external power source and may supply power to an external device (for example, an optic, a flashlight, a mobile phone, or any other external device). For example, the power storage 18 may be a rechargeable battery (such as, a lithium-ion, Li-ion, battery, for example). Alternatively, the power storage 18 may be a non-rechargeable battery that may be replaced by a user (such as, a CR123 battery, for example).

The circuitry 22 may include one or more circuit boards 252 (for example, two circuit boards 252a, 252b) housing wiring, controllers, actuators, etc., for controlling and executing the functions of the video recorder 10. The circuit boards 252 may receive data from an external device (for example, an optic, a thermal optic, or another video source supplying a video input or video stream) through a port 256 (such as a universal serial bus, USB, port) positioned on a surface of the housing 14. The port 256 may extend through the aperture 202 in the housing 14 and may be covered by the cover 228. The port 256 may provide a connection between the cable (not shown) and the circuitry 22 for data transmission and/or power transmission. For example, as described below, data and power may be transmitted simultaneously through the port 256. The port 256 may be covered by the cap 240 that engages the housing 14 to protect the port 256 from dust or other debris from unintentionally entering the port 256.

The circuit boards 252 may receive data from a sound input (for example, an on-board microphone or other sound input) 260 positioned on a surface of the housing 14. The sound input 260 may provide audio captured by the on-board microphone.

The circuit boards 252 may transmit data to a memory such as an internal memory or an external memory. For example, the internal memory may be a random access memory (RAM), a read only memory (ROM), or another internal memory. For example, the external memory may be a memory card (such as a secured digital, SD, card, an XD card, or another memory card), a memory stick (such as an external hard drive, external flash drive, or another memory stick), or another external memory. The external memory may connect with the circuit boards 252 through a memory port 264 in the housing 14. For example, the memory port 264 may be a memory card slot or memory stick port. The memory port 264 may extend through the aperture 212 in the housing 14 and may be covered by the cap 216 to protect the memory port 264 from dust or other debris from unintentionally entering the memory port 264.

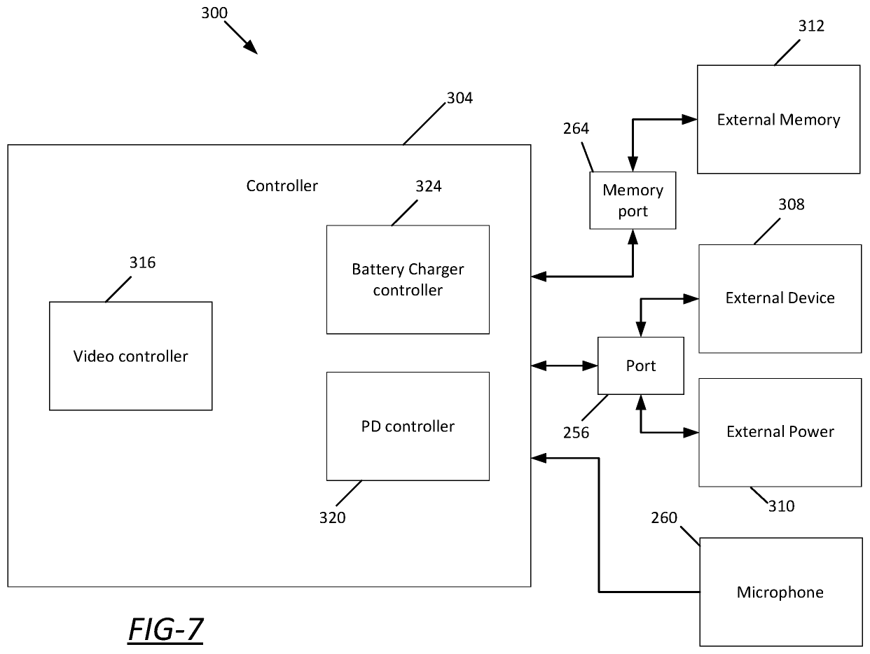

FIG. 7 is a schematic view of a control system 300 for the video recorder 10. A controller 304 may be in communication with the sound input, such as the microphone, 260, an external device 308 through the port 256, an external power source 310 through the port 256, and an external memory 312 through the memory port 264. For example, the external device 308 may include a video source, a device that draws power, or a combination thereof. During times where the video recorder 10 is intended as a stand-alone power supply, the external device 308 may be a powered optic, a flashlight, a mobile phone, or any other device that requires power to operate. During times where the video recorder 10 is intended as a video recorder or both a video recorder and a power supply, the external device may be a powered optic, a digital optic, a digital video source, an analog video source, a thermal optic, or any other device providing a video feed to the video recorder.

For example, the port 256 may be a universal serial bus (USB) connector (for example, a USB Type-C connector) and may include at least four pins. At least two pins may be configured to permit data flow through the port 256. At least two pins may be configured to permit power flow through the port 256. For example, the pins may include super speed transmitter (SSTX/SSRX) pin(s), negative data terminal (−D) pin(s), positive data terminal (+D) pin(s), voltage bus (VBUS) pin(s), ground (GND) pins(s), or any other data transmission and/or power transmission pins.

For example, the external device 308 may be connected to the port 256 with a USB cable, such as a USB Type-C cable, a USB PD spec cable, or another USB type cable, and the external power source 310 may be connected to the port 256 with a USB cable, such as a USB Type-C cable, a USB PD spec cable, or another USB type cable. The controller 304 may include a video controller 316 (for example, a digital video recorder, DVR, controller, an analog video recorder controller, etc.), a power delivery (PD) controller 320, and a battery charger controller 324.

The control system 300 controls both the external video recorder and the auxiliary power source aspects of the video recorder 10. The video controller 316 may be in communication with the sound input, such as the microphone, 260, the external device 308 through the port 256, and the external memory 312 through the memory port 264.

The video controller 316 may be in communication with the port 256 to capture video output from the external device 308. For example, the video controller 316 may be a System on Chip (SoC) and the external device 308 may be a thermal optic. The video output from the external device 308 may be a digital video output or an analog video output.

The video controller 316 may be in communication with the sound input 260 (for example, the microphone). The video controller 316 may receive a sound input from the microphone 260 and combine the sound input with the video output from the external device 308. For example, the video controller 316 may match a time stamp from the video output from the external device 308 with a time stamp at which the sound input from the microphone 260 was recorded. Alternatively, the audio and video outputs may be combined using a multimedia software framework or program.

The video controller 316 may also apply a watermark to the video output from the external device 308. For example, the watermark may be a logo applied to the video image. The watermark may be applied during image processing or during combination of the sound and video image. For example, the watermark may be added to, or superimposed on, each frame of the video.

After optionally combining the video output from the external device 308 and the sound input from the microphone 260 and optionally adding the watermark, the video controller 316 may generate an output video file. The video controller 316 may save the output video file to the external memory 312. For example, the video controller 316 may communicate the output video file to the memory port 264 where the output video file is passed to the external memory 312 for saving.

The PD controller 320 may be in communication with the external device 308 through the port 256. Alternatively, the PD controller 320 may be in communication with the external power supply 310 through the port 256.

The PD controller 320 may detect a cable attach event and a cable detach event. For example, the PD controller 320 may detect a cable attach or cable detach event by monitoring the resistance levels on the Configuration Channel (CC) pins per the USB Type-C specification. The PD controller 320 monitors both CC pins, which are in a floating state when nothing is attached. Upon cable attachment, one of the CC lines will be directly pulled down to ground through the external device pull-down resistor, signaling that a connection has been made. Once connection is established, a voltage divider is set between the video recorder pull-up resistor provided by the PD controller and external device pull-down resistor, fixing the voltage level on the CC wire for communications. Alternatively, if a connector other than a USB Type-C connector is attached, the PD controller may detect a cable attach or detach event by monitoring the resistance level on any one of the pins or by any other method.

The PD controller 320 may detect a cable orientation by monitoring the Configuration Channel (CC) pins per the USB Type-C specification. In a USB Type-C connector configuration, the PD controller 320 may detect the cable orientation simultaneously with detecting the cable attachment. The orientation of the plug and cable is defined according to which CC pin detects a valid resistance after the attach event. In the USB Type-C connector, the pins are formed in pairs, and, thus, either cable orientation is correct. The PD controller 320 may determine which of the pairs transmits the data signal based on the orientation. In an alternative connector configuration, the cable orientation may be detected by monitoring an order or location of pins on the cable. For example, the pins on the cable may include one or more of a super speed transmitter (SSTX/SSRX), negative data terminal (−D) pins, positive data terminal (+D) pins, voltage bus (VBUS) pins, and ground (GND) pins. If the pins of the port 256 correlate with the pins on the connector, the PD controller 320 may detect that the cable orientation is correct. Otherwise, the PD controller 320 may detect that the cable orientation is incorrect.

The PD controller 320 communicates with the external device 308 to provide a current capability of the power system. For example, the PD controller 320 may communicate on a Configuration Channel (CC) wire using a USB power delivery (PD) protocol to advertise the current capability (for example, that the Video Recorder can source). Alternatively, the PD controller 320 may communicate on a wire offering high speed communication or any other communication that is appropriate. The current capability of the power system from the video recorder 10 may be up to 45 Watts (W) per USB Power Deliver (PD) spec v3.0 for a USB 2.0 and BC 1.2 specs cable.

The PD controller 320 may enable an appropriate power path for the VBUS. For example, the PD controller 320 may communicate with the battery charge controller 324 to enable a power path between the power storage 18 and the port 256 through the VBUS pin to the USB connector.

The PD controller 320 may be capable of fast role swap support. For example, the PD controller 320 may be capable of changing power roles in real time, or on the fly. When the external device 308 is also capable of fast role swap, the PD controller 320 may engage in fast role swap support. The power roles involved may be source, sink, and dual role power (DRP). When the power storage 18 of the video recorder 10 is a power supply to the external device 308, the video recorder 10 is a source. When the power storage 18 is recharging, the video recorder 10 is a sink. Since the video recorder 10 is configured to both be a source and a sink, it is called a dual role power device. During fast role swap, the video recorder 10 may alternate between a source and a sink role in real time.

The PD controller 320 may also support battery charging through the USB Battery Charging (BC) 1.2 spec. The PD controller 320 may communicate with the battery charge controller 324. The battery charge controller 324 may communicate with the external power 310 through the port 256 to charge the internal power storage 18.

The battery charger controller 324 may communicate with the external power 310 to receive the current capabilities of the external power 310 device. The battery charger controller 324 may determine wither the current capabilities of the external power 310 are sufficient to meet battery charging of the internal power storage 18. The battery charger controller 324 may negotiate with the external power 310 to provide either the maximum capabilities of the external power 310 or the charging capability necessary to charge the internal power storage 18,

The battery charge controller 324 may provide the current capabilities of the power system to the PD controller 320. The current capabilities of the power system may be determined by evaluating the system requirements, the power storage 18 charge level, and the power levels negotiated with the connected external power 310 (voltage and current capability of the connected device per USB Power Delivery specification). For example, the current capability of the power system from the video recorder 10 may be up to 45 Watts (W) per USB Power Deliver (PD) spec v3.0 for a USB 2.0 and BC 1.2 specs cable.

Alternatively, in some configurations, the battery charge controller 324 may cooperate with a powered rail on the firearm to deliver electrical current to the power storage 18. In these configurations, bottom surface 66 of the channel 70 may include a power input port that electrically connects to the power storage 18.

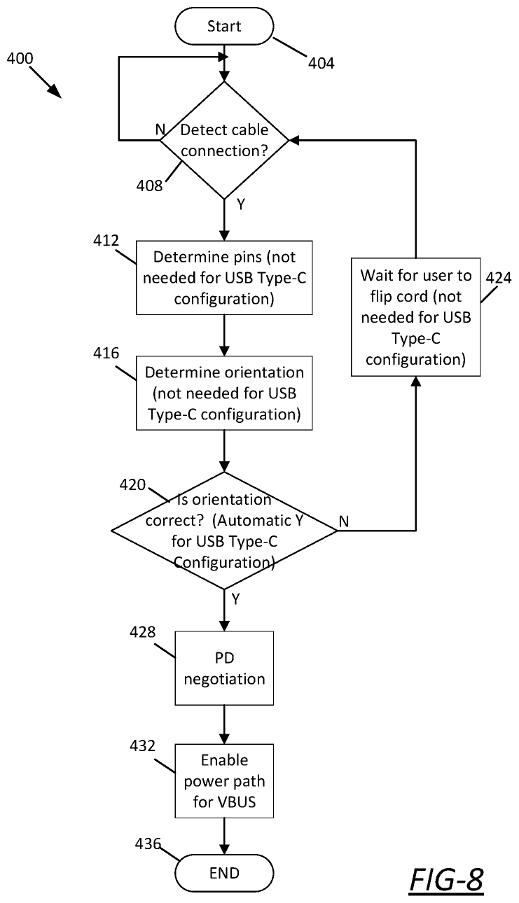

Now referring to FIG. 8, a method 400 for providing power to the external device 308 is illustrated. Method 400 starts at 404. At 408, the controller 304 determines whether there is a cable connection at port 256. For example, the cable connected to the port 256 may be a USB cable, such as a USB Type-C cable, a USB PD spec cable, or another USB type cable.

The controller 304 may determine whether there is a cable connection by monitoring the Configuration Channel (CC) pins per the USB Type-C specification. As previously described, the controller 304 may monitor both CC pins, which are in a floating state when nothing is attached. Upon cable attachment, one of the CC lines will be directly pulled down to ground through the external device pull-down resistor, signaling that a connection has been made. Alternatively, if a connector other than a USB Type-C connector is attached, the controller 304 may detect a cable attach or detach event by monitoring the resistance level on any one of the pins or by any other method.

If the controller 304 does not detect a cable connection, the method 400 returns to 404. If the controller 304 determines that there is a cable connection, the method 400 moves to 412.

At 412, the pin types and locations are determined. For example, the pins may include SSTX, SSRX, −D, +D, VBUS, and GND pins. The pin types may be determined by providing a signal from the corresponding pins on the port 256 and determining whether they are dropped or received by the pin on the cable. In embodiments having a USB Type-C connector, pin types and locations do not need to be determined. For a USB Type-C connector, the pins are formed in pairs, and, thus, in either cable orientation, the pin location is the same.

At 416 the cable orientation is determined. For example, the connector may include SSTX pins, SSRX pins, −D pins, +D pins, VBUS pins, and GND pins. The controller 304 may determine whether the pins on the connector engage with correlating pins on the port 256. In embodiments having a USB Type-C connector, the pins are formed in pairs, and, thus, either cable orientation may be correct. The orientation of the plug and cable is defined according to which CC pin detects a valid resistance after the attach event. The controller 304 may determine which of the pairs transmits the data signal based on the orientation. In a USB Type-C connector configuration, the controller 304 may detect the cable orientation simultaneously with detecting the cable attachment at 408.

At 420, the controller 304 determines whether the cable orientation is correct. For example, the controller may detect whether the SSTX, SSRX, or D pins on the cable match with the SSTX, SSRX, or D pins on the port 256 and the VBUS and GND pins on the cable match with the VBUS and GND pins on the port 256. If true, the controller 304 may detect that the cable orientation is correct. If false, the controller 304 may detect that the cable orientation is incorrect.

If the cable orientation is not correct at 420, the controller 304 waits for a user to flip the cable at 424. Method 400 then returns to 408.

If the cable orientation is correct at 420, power distribution is negotiated at 428. For example, the controller 304 communicates with the external device 308 to provide a current capability of the power system. For example, the controller 304 may communicate on a configuration channel (CC) wire using a USB power delivery (PD) protocol to advertise the current capability. For example, the current capabilities of the power system may be determined by evaluating the system requirements, the power storage 18 charge level, and the power request received from the external device 308. For example, the current capability of the power system from the video recorder 10 may be up to 45 Watts (W) per USB Power Deliver (PD) spec v3.0 for a USB 2.0 and BC 1.2 specs cable.

During the negotiation of power distribution, the controller 304 may receive a requested power from the external device 308. The controller 304 may compare the requested power with the current capability of the power system and determine whether the request can be met. If the request cannot be met, the controller 304 may provide the capabilities to the external device 308 for acceptance. If the request can be met, the controller may move to 432.

At 432, the power path is enabled. The controller 304 may enable an appropriate power path for the VBUS. For example, controller 304 may enable a power path between the power storage 18 and the port 256 through the VBUS pin to the USB connector.

At 436, method 400 ends.

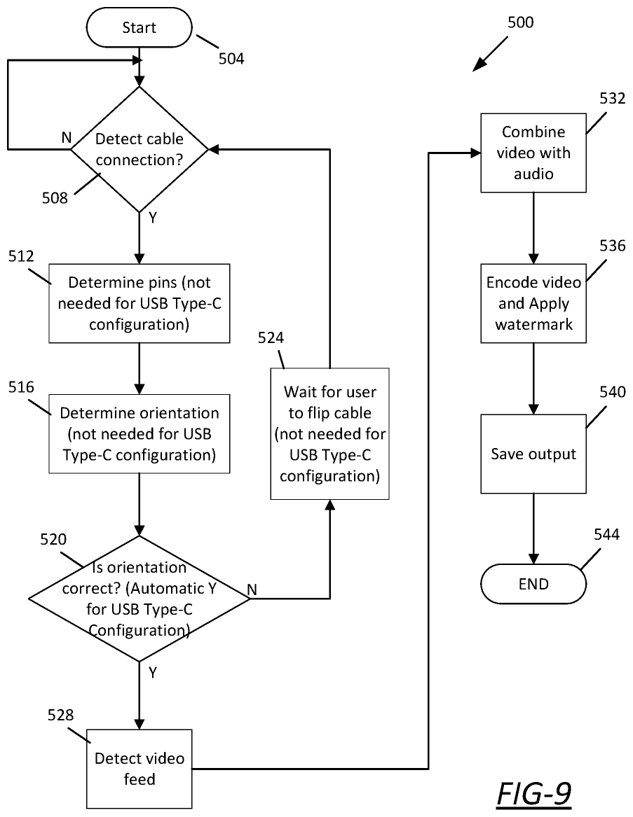

Now referring to FIG. 9, a method 500 for receiving, processing, and storing video is illustrated. Method 500 starts at 504. At 508, the controller 304 determines whether there is a cable connection at port 256. For example, the cable connected to the port 256 may be a USB cable, such as a USB Type-C cable, a USB PD spec cable, or another USB type cable.

The controller 304 may determine whether there is a cable connection by monitoring the Configuration Channel (CC) pins per the USB Type-C specification. As previously described, the controller 304 may monitor both CC pins, which are in a floating state when nothing is attached. Upon cable attachment, one of the CC lines will be directly pulled down to ground through the external device pull-down resistor, signaling that a connection has been made. Alternatively, if a connector other than a USB Type-C connector is attached, the controller 304 may detect a cable attach or detach event by monitoring the resistance level on any one of the pins or by any other method.

If the controller 304 does not detect a cable connection, the method 500 returns to 504. If the controller 304 determines that there is a cable connection, the method 500 moves to 512.

At 512, the pin types and locations may be determined. For example, the pins may include SSTX, SSRX, −D, +D, VBUS, and GND pins. The pin types may be determined by providing a signal from the corresponding pins on the port 256 and determining whether they are dropped or received by the pin on the cable. In embodiments having a USB Type-C connector, pin types and locations do not need to be determined. For a USB Type-C connector, the pins are formed in pairs, and, thus, in either cable orientation, the pin location is the same.

At 516 the cable orientation may be determined. For example, the connector may include SSTX pins, SSRX pins, −D pins, +D pins, VBUS pins, and GND pins. The controller 304 may determine whether the pins on the connector engage with correlating pins on the port 256. In embodiments having a USB Type-C connector, cable orientation does not need to be determined. For a USB Type-C connector, the pins are formed in pairs, and, thus, either cable orientation is correct.

At 520, the controller 304 may determine whether the cable orientation is correct. For example, in a configuration for a USB Type-C connector, the orientation of the plug and cable is defined according to which CC pin detects a valid resistance after the attach event. In the USB Type-C connector, the pins are formed in pairs, and, thus, either cable orientation is correct. The PD controller 320 may determine which of the pairs transmits the data signal based on the orientation. Alternatively, for example, in a configuration using an alternative connector, the controller 304 may determine whether the SSTX pin(s), SSRX pin(s), D pins, VBUS pin(s), and/or GND pin(s) on the cable correlate or match with the pins on the port 256. If true, the controller 304 may detect that the cable orientation is correct. If false, the controller 304 may detect that the cable orientation is incorrect, or upside down.

If false at 520, the controller 304 waits for a user to flip the cable at 524. Method 500 then returns to 508.

If true at 520, a video feed is detected at 528. For example, the controller 304 receives video feed output from the external device 308 through the port 256. For example, the video feed may be sent to the controller 304 in real time as the video is taken, without storing the video feed in the external device 308.

At 532, the video feed is combined with audio. For example, the controller 304 may receive data from a sound input (for example, an on-board microphone or other sound input) 260 positioned on a surface of the housing 14. The sound input 260 may provide audio captured by the on-board microphone. For example, the controller 304 may match a time stamp from the video output from the external device 308 with a time stamp at which the sound input from the microphone 260 was recorded. Alternatively, the audio and video outputs may be combined using a multimedia software framework or program.

At 536, the video is encoded and a watermark is added to the video from the external device 308. For example, the watermark may be a logo applied to the video image. The watermark may be applied concurrently with or after combination of the sound and video image at 532. For example, the watermark may be added to, or superimposed on, each frame of the video.

For example, the video may be encoded to prepare the video for output. During encoding, the video may be compressed, formatted, and/or edited to meet specifications for recording and playback. Analog video signals may be converted into digital signals. Any applicable video encoder software may be used to encode the video.

At 540, an output video file may be generated and saved. For example, the controller 304 may save the output video file to the external memory 312. For example, the video controller 316 may communicate the output video file to the memory port 264 where the output video file is passed to the external memory 312 for saving.

The method ends at 544.

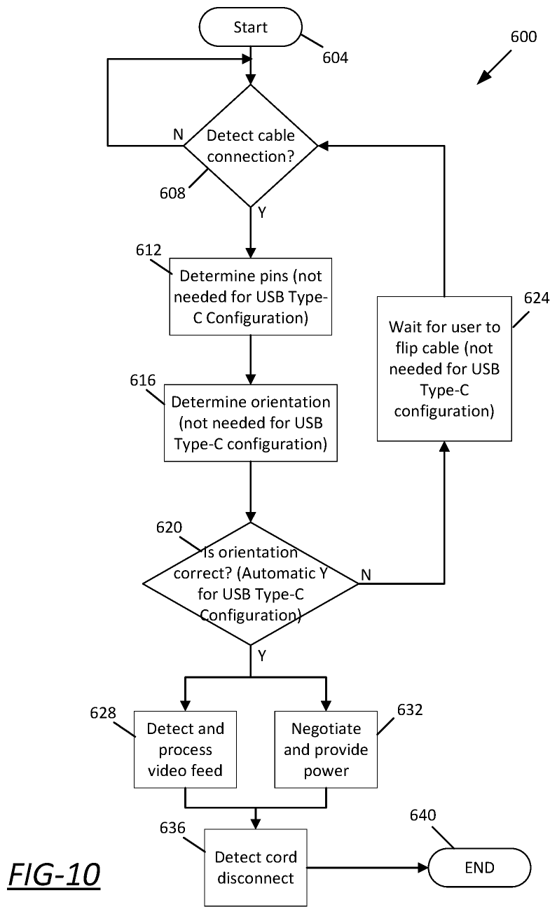

Now referring to FIG. 10, a method 600 for simultaneously providing power and receiving video through the port 256 is illustrated. Method 600 starts at 604. At 608, the controller 304 determines whether there is a cable connection at port 256. For example, the cable connected to the port 256 may be a USB cable, such as a USB Type-C cable, a USB PD spec cable, or another USB type cable.

The controller 304 may determine whether there is a cable connection by monitoring the Configuration Channel (CC) pins per the USB Type-C specification. As previously described, the controller 304 may monitor both CC pins, which are in a floating state when nothing is attached. Upon cable attachment, one of the CC lines will be directly pulled down to ground through the external device pull-down resistor, signaling that a connection has been made. Alternatively, if a connector other than a USB Type-C connector is attached, the controller 304 may detect a cable attach or detach event by monitoring the resistance level on any one of the pins or by any other method.

If the controller 304 does not detect a cable connection, the method 600 returns to 604. If the controller 304 determines that there is a cable connection, the method 600 moves to 612.

At 612, the pin types and locations may be determined. For example, the pins may include SSTX, SSRX, −D, +D, VBUS, and GND pins. The pin types may be determined by providing a signal from the corresponding pins on the port 256 and determining whether they are dropped or received by the pin on the cable. In embodiments having a USB Type-C connector, pin types and locations do not need to be determined. For a USB Type-C connector, the pins are formed in pairs, and, thus, in either cable orientation, the pin location is the same.

At 616 the cable orientation may be determined. For example, the connector may include SSTX pins, SSRX pins, −D pins, +D pins, VBUS pins, and GND pins. The controller 304 may determine whether the pins on the connector engage with correlating pins on the port 256. In embodiments having a USB Type-C connector, the orientation of the plug and cable is defined according to which CC pin detects a valid resistance after the attach event. In the USB Type-C connector, the pins are formed in pairs, and, thus, either cable orientation is correct. The PD controller 320 may determine which of the pairs transmits the data signal based on the orientation.

At 620, the controller 304 may determine whether the cable orientation is correct. For example, the controller 304 may determine whether the pins on the connector engage with correlating pins on the port 256. Alternatively, for a USB Type-C connector, the pins are formed in pairs, and, thus, either cable orientation is correct. If true, the controller 304 may detect that the cable orientation is correct. If false, the controller 304 may detect that the cable orientation is incorrect.

If the cable orientation is not correct at 620, the controller 304 waits for a user to flip the cable at 624. Method 600 then returns to 608.

If the cable orientation is correct at 620, a video feed is detected, processed, and stored at 628. For example, the controller 304 receives video feed output from the external device 308 through the port 256. For example, the video feed may be sent to the controller 304 in real time as the video is taken, without storing the video feed in the external device 308. The controller 304 may process the video feed by following the steps previously discussed in FIG. 9. For example, the controller 304 may combine the video feed with audio, apply a watermark, and store the resulting video file.

Simultaneously with detecting, processing, and storing a video feed at 628, the controller 304 may negotiate and provide power to the external device 308 at 632 through the same port 256. For example, the controller 304 may negotiate and provide power by following the steps previously discussed in FIG. 8.

At 636 the controller 304 may detect a cable disconnect. For example, the controller 304 may detect a disengagement of the pins or lack of communication with the pins at port 256. Method 600 then ends at 640.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A video recorder battery pack for a firearm, said video recorder battery pack comprising:
a housing;
a power supply disposed within the housing; and
a port in the housing configured to connect with a video source, said port being configured to simultaneously receive a video output from the video source and provide power to the video source.

2. The video recorder battery pack of claim 1, wherein the port is a universal serial bus (USB) port.

3. The video recorder battery pack of claim 1, wherein the port includes at least four pins, at least two of the at least four pins being configured to permit data flow and at least two of the at least four pins being configured to permit power flow.

4. The video recorder battery pack of claim 1, wherein the video source is a digital optic.

5. The video recorder battery pack of claim 1, wherein the port is configured to provide power to external devices other than the video source.

6. The video recorder battery pack of claim 1, further comprising a power controller configured to control power supply through the port, said power controller being configured to detect a cable attachment, a cable detachment, and a cable orientation, determine power delivery supply, enable a power path, and determine a voltage and current output for the power, said voltage and current output being based on the power delivery supply.

7. The video recorder battery pack of claim 1, further comprising a microphone in the housing, said microphone being configured to receive sound.

8. The video recorder battery pack of claim 7, further comprising a video controller configured to mate the video output from the video source and sound received by the microphone.

9. The video recorder battery pack of claim 1, wherein the power supply is a battery and the port is configured to connect with an external power supply to charge the battery.

10. The video recorder battery pack of claim 1, further comprising a mount fixed to the housing and configured to mount the housing to a firearm or a firearm accessory.

11. The video recorder battery pack of claim 1, wherein the port is configured to receive the video output from the video source in real time as images are captured by the video source.

12. A video recorder battery pack for a firearm, said video recorder battery pack comprising:
a housing;
a port disposed in the housing and configured to receive a video output from a video source;
a microphone configured to receive sound; and
a controller configured to combine the video output from the video source with the sound received by the microphone.

13. The video recorder battery pack of claim 11, wherein the port is further configured to simultaneously provide power to the video source.

14. The video recorder battery pack of claim 11, wherein the video source is a digital optic, and the port is a universal serial bus (USB) port.

15. A battery pack for a firearm, said battery pack comprising:
a housing configured to be mounted to a firearm;
a controller configured to provide power to an external device, said controller being disposed within the housing;
a strap slot integral with the housing, said strap slot being configured to receive a strap to mount the housing; and
a mechanical mount integral with said housing, said mechanical mount being configured to mount the housing to the firearm or a firearm accessory.

16. The battery pack of claim 15, wherein the mechanical mount is one of a rail mount, a mount knob, a lever, a screw, or a fastener.

17. The battery pack of claim 15, further comprising a lanyard loop integral with the housing, the lanyard loop being configured to receive a lanyard.

18. The video recorder battery pack of claim 17, wherein the housing includes a plurality of lanyard loops or a plurality of strap slots.

19. The video recorder battery pack of claim 15, wherein the external device is a video source and the controller is configured to simultaneously receive a video output from the video source and provide power to the video source through a single port in the housing.

20. The video recorder battery pack of claim 19, wherein the video source is a digital optic.
